(19) United States
(12) Patent Application Publication
(10) Pub. No.: US 2008/0243485 A1
(43) Pub. Date: Oct. 2, 2008

(54) METHOD, APPARATUS, SYSTEM, USER INTERFACE AND COMPUTER PROGRAM PRODUCT FOR USE WITH MANAGING CONTENT

(75) Inventors: John RIEMAN, Helsinki (FI); Minna HEKANAHO, Oulu (FI); Minna Koutonen, Oulu (FI); Tero Rantonen, Oulu (FI); John Hard, Malmo (SE)

Correspondence Address: PERMAN & GREEN, 425 POST ROAD, FAIRFIELD, CT, 06824, US

(73) Assignee: NOKIA CORPORATION, Espoo (FI)

(21) Appl. No.: 11/693,090

(22) Filed: Mar. 29, 2007

(51) Int. Cl. G06F 17/21

(52) U.S. Cl. 704/10

(57) ABSTRACT

A method for adding content to a dictionary for use with a communication terminal, including: parsing a media content for one or more expressions; extracting the expressions from the media content; and providing the expressions to the dictionary for subsequent retrieval.

### FIELD

The disclosed embodiments relate to a method for improving dictionaries of communication terminals. The disclosed embodiments further relate to an apparatus, a system, a user interface, and a computer program product for implementation of said method.

### BACKGROUND

There is a need for providing users of communication terminals with a better tie-in to online social networking pages or people communities. Internet users, especially of younger generations, are making these the centre of their social life.

In order to meet the demands of the connected society of today, there is an increasing need for providing functional and attractive services and solutions to communication terminals, especially with regards to communicative capabilities.

The dictionary, always being available to a user, is a key tool in communications. Among its advantages, a dictionary for instance provides intelligent solutions for efficiently composing messages and for spelling correction. With increased functionality and far-reaching enhancements, it is expected that the dictionary will become a part of a user's online and messaging personality.

It is therefore a problem to provide an improved dictionary service.

### SUMMARY

It would be advantageous to wholly or partly overcome the above disadvantages and drawbacks of the prior art.

The disclosed embodiments relate to functionality where a user can scan a particular media file for expressions, quotes, chorus lines or the like, and subsequently store the resulting media segments as audio, video or textual interpretation.

More specifically, in one embodiment a communication terminal is provided that is arranged to enable a user to adopt a style of language which is coupled to a media content. As an advantage, it will make people more stylus and cool in their way of communication.

In another embodiment, more sophisticated and comprehensive dictionaries are provided for use with mobile communication terminals.

The above, together with numerous other advantages and features, which will become evident from the below description, are accomplished according to a first aspect in accordance with the disclosed embodiments by a method for adding content to a dictionary for use with a communication terminal, comprising: parsing a media content for one or more expressions; extracting said expressions from said media content; and providing said expressions to said dictionary for subsequent retrieval.

Hereby, for instance a soundtrack of a movie or music may be scanned for keywords and phrases. The keywords may then be added to a dictionary stored in for instance a communication terminal. Advantageously, a translation of the keywords and phrases may also be stored.

As an advantage, a user having particular interest in for instance a film, may scan the film for keywords and expressions. The keywords and expressions may be stored in audio or video format for subsequent retrieval, and further be extracted and stored as text. With the keywords and expressions available in a text version, a user can incorporate these conveniently in messages, or expediently retrieve the related audio and video clips.

Since considerable processing power may be necessary for the recognition and extraction of expressions when parsing a media content, this process may preferably be performed on a server, in whole or in part.

However, the parsing and extraction may also be performed on other computing devices, such as communication terminals, mobile phones, computers or personal digital assistants.

The term “dictionary” is in this context to be construed as a catalogue, dictionary or list of textual or media entries.

The term “parse” is in this context to be construed as parsing, analysing, decoding or scanning a content to identify parts of speech, music or the alike.

The term “expression” is in this context to be construed as being anything from the group of: partial or complete key words, phrases, terms, names facts, or quotes. The term “media content” is in this context to be construed as audio or visual information.

The method according to the first aspect may further comprise storing of said expressions in connection with said communication terminal.

Hereby, expressions may be stored on a memory device connectable to a communication terminal or on a memory of the communication terminal.

As an advantage, the expressions may then be viewed separately, for instance from another viewer.

According to one embodiment of the method according to the first aspect, the parsing may be performed within a predetermined timeframe of said media file.

The term “timeframe” is in this context to be construed as a certain section or segment of a media file, for instance comprising a particular expression of interest. A user may for instance specify in an editor a particular expression to identify through parsing.

Hereby, a particular segment of a media file may be parsed for expressions. Hence, the amount of information to be parsed is reduced. As an advantage, the parsing process becomes more efficient.

According to one embodiment of the method according to the first aspect, the parsing may involve parsing for a predetermined expression.

Hereby, a user may enter a specific expression to parse a media content for. As an advantage, a user can search a media content for a specific expression in said media content. It is especially an advantage when, for instance, a user wants to extract a particular expression in its original media format, such as speech or lyrics.

The method of the above mentioned first aspect may further comprise translating said one or more expressions into a predetermined language.

Hereby, a user can instantly acquire a translation of an expression.

As an advantage, a user can acquire an expression in his or her language for better understanding or to better fit in with a context, for instance when composing a message.

The parsing of the method of the above mentioned first aspect may further involve identifying said expressions with dynamic or temporal information.

Hence, enhanced functionality is available when parsing, identifying and extracting expressions from a media content, for instance speech, lyrics, and/or chorus parts.

As an advantage, it is possible also to retrieve expressions otherwise being difficult to identify, such as key-phrases with long pauses on both ends. As a further advantage, also chorus parts, often of a higher frequencies, louder and more extended, may be identified. This is enabled by analysing the media content. Hereby, information relating to time and timing, and the range of volume of for instance musical sound are included in the analyse when parsing for expressions.

The method of the above mentioned first aspect may further involve prioritized extraction of expressions determined by frequency of occurrence.

Hereby, key phrases may be identified on the basis of relative frequency of occurrence.

As an advantage, extraction of irrelevant expressions from a media content may be reduced due to supposedly less frequent occurrence.

The method of the above mentioned first aspect may further comprise storing said expressions a data segment.

Hereby, expressions can be stored in a data file for convenient browsing or editing.

An advantage of this is that a user can manage and edit expressions in a dictionary in any desired fashion.

The method of the above mentioned first aspect may further comprise associating a media content with said one or more identified expressions.

Also in this context, the term “media content” is to be construed as audio or visual information. Particularly, the media content may comprise an identified expression in its original format, such as speech or audible lyrics. The associated media content may be stored in connection with said dictionary. It can also be stored separately from said dictionary, as long as it is accessible to said communication terminal, for instance on a server accessed over a network.

Hereby, a media content related to an expression can be retrieved conveniently.

An advantage of this is that a user instantly can access a particular media content referred to in a textual interpretation.

According to an expedient embodiment, the associating may involve the provision of a link to said media content. The link may for instance be positioned below a expression to which it is related, or by incorporating it with the textual representation.

Hereby, the association is presented to a user in a clear and convenient way.

An advantage of this is that a user conveniently can access an associated media content by interacting the provided link.

The method of the above mentioned first aspect may further comprise sharing of said content.

Hereby, users may exchange personalized dictionary content with each other.

As an advantage, personalized dictionary content is made more accessible to other users.

The above embodiments, together with numerous other embodiments, advantages and features, which will become evident from the below description, are accomplished according to a second aspect of the disclosed embodiments by an apparatus comprising: a parser for parsing a media content for one or more expressions;

an extractor for extracting said expressions from said media content; and an output for providing said expressions to said dictionary for subsequent retrieval.

Hence, the method in the first aspect of the invention may be implemented in an apparatus.

As an advantage, an efficient and convenient process for adding content to a dictionary is achieved.

The apparatus according to the second aspect may comprise a communication terminal or a server.

Hence, the method according to the first aspect of the disclosed embodiments may be implemented in a communication terminal or a server. An advantage of implementing the method in a communication terminal is the reduced need for on-line activity towards a server. On the other hand, the use of a server may advantageously be more efficient, for instance enabling more demanding processing of media content.

The above, together with numerous other advantages and features, which will become evident from the below description, are accomplished according to a third aspect of the disclosed embodiments by a system for adding content to a dictionary for use with a communication terminal, said system comprising a communication terminal, a server, and a network connecting said communication terminal and said server, wherein said server comprises: a parser for parsing a media content for one or more expressions; an extractor for extracting said expressions from said media content; and an output for providing said expressions to said dictionary for subsequent retrieval with a communication terminal.

Hence, a system is provided that provides a convenient solution involving interaction between a communication terminal and a server in a communications network.

As an advantage, the system enables an efficient solution where the components are working nicely together to provide an efficient service for the user of a communication terminal.

The above, together with numerous other advantages and features, which will become evident from the below description, are accomplished according to a fourth aspect in accordance with the disclosed embodiments by a computer program product, such as a computer-readable medium, comprising software instructions that, when executed in an electronic apparatus, performs the method according to said first aspect of the disclosed embodiments.

Hence, the invention may conveniently and advantageously be provided to data processing apparatus for efficiently implementing the method according to the first aspect of the disclosed embodiments.

The above, together with numerous other advantages and features, which will become evident from the below description, are accomplished according to a fourth aspect in accordance with the disclosed embodiments by a user interface comprising a display, and an input receiver, wherein said user interface is arranged to facilitate adding of content to a dictionary for use with a communication terminal by displaying a media content to be parsed for one or more expressions, receiving input for initiating said parsing and extracting of said expressions from said media content, and displaying said extracted expressions.

Hence, it is provided a solution for a user to conveniently extract expressions from a media content to a dictionary for use in an apparatus such as a communication terminal. An advantage of this is that a user conveniently can administer a process of retrieving expressions from a media content and providing said expressions to a dictionary, especially one integrated with for instance a mobile communication terminal.

### BRIEF DESCRIPTION OF THE DRAWINGS

The invention and its many advantages will be described in more detail below with reference to the accompanying schematic drawings, which for the purpose of illustration show some non-limiting embodiments and in which

FIG. 1 shows a flow chart illustrating a method of the disclosed embodiments,

FIG. 2 illustrates schematically a mobile communication terminal; and

FIG. 3 illustrates a system for handling personalized dictionary content according to an embodiment.

All the figures are highly schematic, not necessarily to scale, and they show only parts which are necessary in order to elucidate the invention, other parts being omitted or merely suggested.

### DETAILED DESCRIPTION OF PREFERRED EMBODIMENTS

Dictionaries for use with mobile communication terminals that are available today include pre-installed dictionaries with common words and phrases, downloadable specialized dictionaries such as for translation between languages, and personal dictionaries adapted to learn from a user's commonly used language. Another example is downloadable content dictionaries, for instance film-specific dictionaries comprising phrases from popular films or television series.

Furthermore, also for purposes of learning languages, dictionaries can be useful. Dictionaries integrated in communication terminals provide convenient mobile solutions always at hand. However, the full potential of using dictionaries of communication terminals as powerful tools in connection with learning languages yet remains mainly unexploited. Hence, there is also a need for providing attractive solutions to users of communication terminals interested in learning new languages.

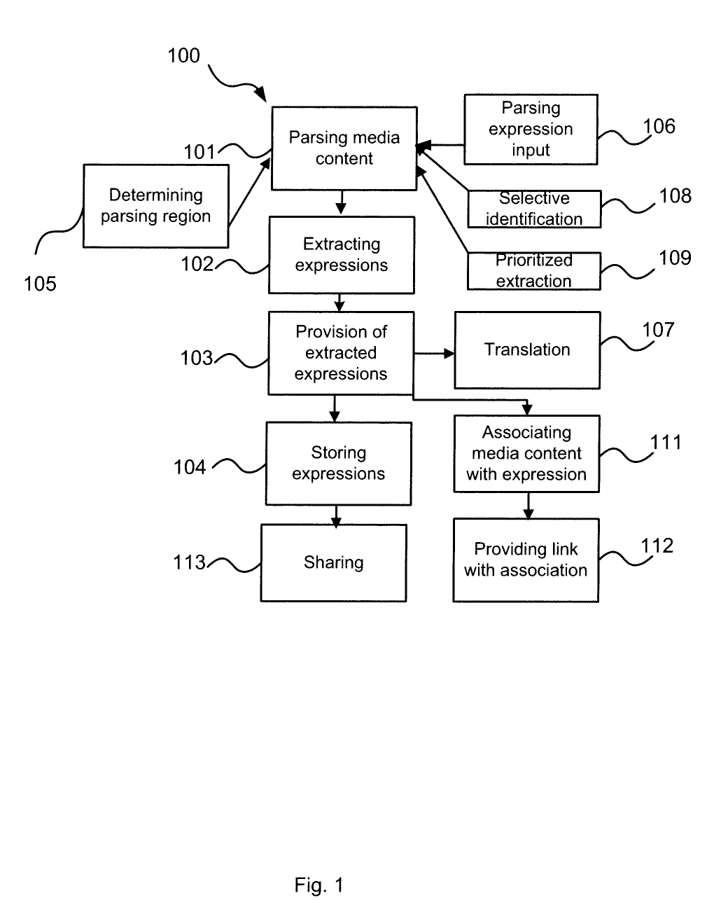

FIG. 1 is a flow chart illustrating a method of an embodiment describing the process for adding content to a dictionary for use with a communication terminal 100.

In a first parsing step 101, a media content is parsed for one or more expressions. In an extracting step 102, said one or more expressions are extracted from said media content, and in an output step 103, said expressions are provided to a dictionary, and preferably stored therein, for subsequent retrieval by said communications terminal.

Optionally, the process further comprises a storing step 104, wherein said expressions are stored in connection with said communication terminal.

Prior to, or in connection with, parsing the media content 101, input for a time interval for which the media content is to be parsed may be provided in a time frame retrieval step 105.

In a case where the parsing involves parsing for a predetermined expression, the expression to be parsed for is provided in a parsing expression provision step 106.

In connection with the provision of the extracted expressions, a translating step 107 may translate said one or more expressions into a predetermined language.

The parsing process may involve a selective identification step 108, wherein said parsing involves identifying said expressions with dynamic or temporal information.

The parsing process may further involve a prioritized extraction step 109 for prioritizing extraction of expressions according to frequency of occurrence.

As a further option, a media content may be associated with said one or more identified expressions in an associating step 111. The association may in a link provision step 112 involve the provision of a link to said media file.

As an additional option, the dictionary may be shared with other users, illustrated with sharing step 113.

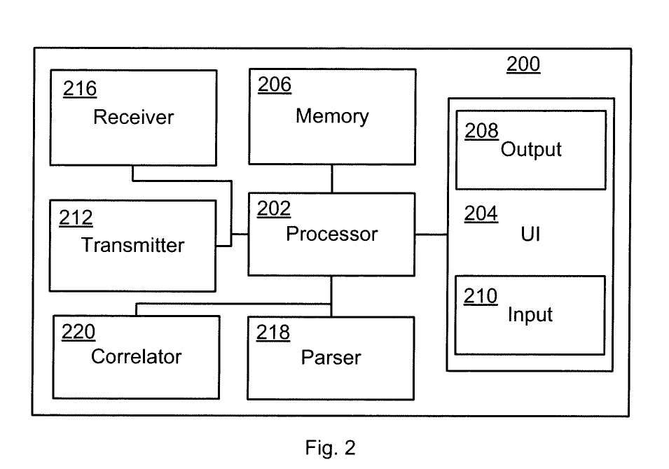

FIG. 2 schematically shows a mobile communication apparatus 200 according to an embodiment. It should be noted that parts not contributing to the core of the invention are left out not to obscure the features of the disclosed embodiments. The mobile communication apparatus comprises a processor 202, a user interface (UI) 204, a memory 206, a transmitter 212, a receiver 216, a parser 218, and an extractor 220.

The memory 206 holds program code for operation of applications of the mobile communication apparatus. The memory 206 also holds data used by the applications. Here, the memory 206 is depicted as a single unit. However, the memory can be two or more units, and/or divided in partitions. Preferably, program code for applications can be downloaded to the memory 206, and the downloaded program code can then be executed by the processor 202.

The user interface (UI) 204 comprises an input 210 and an output 208. The output 208 is arranged to present information to a user, such as text, images, audio, and/or video output related to a media content, or information related to the operation of extracting one or more expressions. The input 210 is arranged to receive input related to media content parsing requests.

The transmitter 212 is arranged to transmit data and the receiver 216 is arranged to receive data to and from a mobile communication network, respectively. The receiver 216 is further arranged to receive a media content. The parser 218 is arranged to parse said media content for expressions, and the extractor 220 is arranged to extract said expressions into textual format.

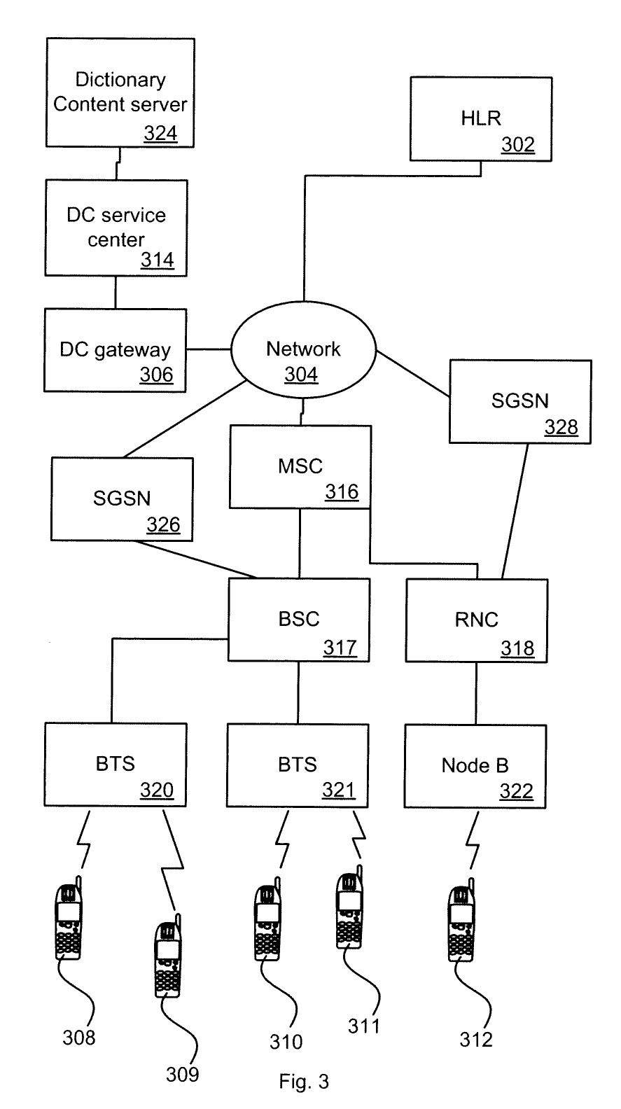

A system architecture for managing a system 300 according to an embodiment is shown in FIG. 3. A Home Location Register (HLR) 302 contains a database (not shown) including relevant subscriber information for provision of telecommunication service. A CCITT specified network 304 interconnects the individual parts of the system 300. A Dictionary Content (DC) gateway 306 is a switching unit routing a Dictionary Content to a mobile communication apparatus 308-312. A Dictionary Content (DC) Service Center 314 and the Dictionary Content (DC) gateway 306 handles and routes the media and dictionary content between the DC Service Center 314 and the network 304. From the network 304, the dictionary content is routed to the mobile communication apparatuses 308-312 via a Mobile Switching Center (MSC) 316 to a Base Station Controller (BSC) 317 and a Base Transceiver Station (BTS) 320, 321, or a Radio Network Controller (RNC) 318 and a Node B 322. Alternatively, the personalized dictionary content is routed to the mobile communication apparatuses 308-312 via a Serving GPRS Support Node (SGSN) 326, 328 to the BSC 317 and the BTS 320, 321, or the RNC 318 and the Node B 322, respectively. The BTS 320, 321 or the Node B 322 establish the air connection to the mobile communication apparatuses 308-312.

According to an embodiment, a network operator or other third party company handling a Dictionary Content server 324 could offer a service for parsing and extracting expressions from a media content provided by for instance a mobile communication terminal. For example a network operator may have a Dictionary Content server 324 supporting a feature where the user may send a parsing request from his mobile communication apparatus 308-312 to the Dictionary Content server 324 by using a special phone number. This Dictionary Content server 324 automatically processes request including parsing and extracting expressions from the media content. The Dictionary Content server 324 is responsible for returning a result to the communication terminal after processing the provided content.

Hence, the disclosed embodiments relate to a method where a user may download a film and also get a dictionary for that film either containing words specific to the film or for a language used in the film. For instance, for the film “Dirty Harry”, expressions stored in an associated dictionary file could be “Make my day, punk!” and “Do you feel lucky?”. For the film “Lord of the rings, expressions could be “Aragorn” or “Frodo”. In addition, even dictionaries for Elfish and Orcish could be downloaded. Expressions from the television series “Startrek” could be “Klingon” or “Beam me up, Scotty!”.

After having parsed a music piece or a film for expressions, a user can download the resulting texual expressions collectively in a file, preferably in a dictionary format. The dictionary is stored in a designated location in the memory of the phone, perhaps in connection with other dictionaries used by the telephone. Immediately thereafter, the dictionary will be accessible for editing purposes, for instance in connection with composing an outgoing message such as a Short Messaging Service (SMS), Multimedia Message Service (MMS) or electronic mail. The user opens an editor for composing an outgoing message and begins to type. As the user is working his way through the message, entering only plain common language words, he decides to add an expression from his favourite film “Dirty Harry”. The user may either begin to type the letters in an expression he remembers from the film, and when he has entered “Mak”, he is presented with a suggestion from the dictionary containing words and expressions from the film “Dirty Harry”: “Make my day, punk!”. The user accepts the suggestion by performing appropriate action, and the expression is inserted into the text body of the message. Alternatively, the user could have opened the dictionary file or a search prompt for accessing and viewing the content of the dictionary file to find the expression.

Although the invention above has been described in connection with preferred embodiments of the invention, it will be evident for a person skilled in the art that several modifications are conceivable without departing from the invention as defined by the following claims.

1. A method for adding content to a dictionary for use with a communication terminal, comprising:
parsing a media content for one or more expressions;
extracting said expressions from said media content; and
providing said expressions to said dictionary for subsequent retrieval.

2. The method according to claim 1, further comprising storing of said expressions in connection with said communication terminal.

3. The method according to claim 1, wherein said parsing is performed within a predetermined timeframe of said media file.

4. The method according to claim 1, wherein said parsing involves parsing for a predetermined expression.

5. The method according to claim 1, further comprising translating said one or more expressions into a predetermined language.

6. The method according to claim 1, wherein said parsing involves identifying said expressions with dynamic or temporal information.

7. The method according to claim 1, further comprising prioritized extraction of expressions determined by frequency of occurrence.

8. The method according to claim 1, further comprising storing said expressions as a data segment.

9. The method according to claim 1, further comprising associating a media content with said one or more identified expressions.

10. The method according to claim 7, wherein said associating involves the provision of a link to said media content.

11. The method according to claim 6, further comprising sharing of said dictionary content.

12. An apparatus comprising:
a parser for parsing a media content for one or more expressions;
an extractor for extracting said expressions from said media content; and
an output for providing said expressions to said dictionary for subsequent retrieval.

13. The apparatus according to claim 12, wherein said apparatus is a communication terminal or a server.

14. A system for adding content to a dictionary for use with a communication terminal, said system comprising a communication terminal, a server, and a network connecting said communication terminal and said server, wherein said server comprises:
a parser for parsing a media content for one or more expressions;
an extractor for extracting said expressions from said media content; and
an output for providing said expressions to said dictionary for subsequent retrieval with a communication terminal.

15. A computer program product, such as a computer-readable medium, comprising software instructions that, when executed in an electronic apparatus, performs the method according to claim 1.

16. A user interface comprising
a display, and
an input receiver,
wherein said user interface is arranged to facilitate adding of content to a dictionary for use with a communication terminal by displaying a media content to be parsed for one or more expressions, receiving input for initiating said parsing and extracting of said expressions from said media content, and displaying said extracted expressions.
